(19) United States
(12) Patent Application Publication
(10) Pub. No.: US 2008/0162444 A1
(43) Pub. Date: Jul. 3, 2008

(54) SYSTEM AND METHOD FOR MONITORING AND PROVIDING PATENT INFORMATION AUTOMATICALLY

(75) Inventors: CHUNG-I LEE, Tu-Cheng (TW); CHIEN-FA YEH, Tu-Cheng (TW); DA-PENG LI, Shenzhen (CN); ZHI-HONG LI, Shenzhen (CN)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/934,788

(22) Filed: Nov. 5, 2007

(30) Foreign Application Priority Data
Dec. 29, 2006 (CN) 200610064584.4

(51) Int. Cl. G06F 17/30

(52) U.S. Cl. 707/4; 707/E17.008

(57) ABSTRACT

A method for monitoring and providing patent information automatically is disclosed. The method includes the steps of determining whether a monitored patent Web site has issued new patents; downloading the new patents if the patent Web site has issued new patents; issuing one or more reports describing information of the downloaded patents; obtaining preconfigured patent search string stored in the database; determining whether the one or more reports contain the whole patent search string; searching the downloaded patents to obtain search results if the one or more reports contain the whole patent search string; saving the search results into the database as an XML document; creating a list according to the XML document; determining whether the number of the search results in the list is null; and sending the list to related users if the number of the search results in the list is not null.

### BACKGROUND OF THE INVENTION

1. Field of the Invention

The present invention relates to a system and method for monitoring and providing patent information automatically.

2. Description of related art

Patent professionals often search for publications relevant to patents. Searches typically arise in two contexts: when looking for “prior art” publications that might invalidate a patent and when looking for publications that might disclose an infringement of a patent.

An ever-increasing number of publications are being published on the Internet, for example, “white papers” published on companies' public websites. Thus, the Internet has become a more and more important resource for patent professionals looking for publications relevant to patents. However, patent professionals have for the most part relied on general Internet search techniques, such as applying keywords to general-purpose Internet search engines, to discover patent-relevant publications on the Internet.

Therefore, what is also needed is a system and method for monitoring and providing patent information automatically, which can be used for downloading search results from patent Web sites automatically and efficiently.

### SUMMARY OF THE INVENTION

A system for monitoring and providing patent information automatically is disclosed. The system includes an application server and a database coupled to the application server, the application server being connected with one or more patent Web sites via a network. The application server includes a determining module for determining whether a monitored patent Web site has issued new patents; a downloading module for downloading the new patents and saving the new patents into the database if the monitored patent Web site has issued new patents; an issuing module for issuing one or more reports describing information of the downloaded patents; an obtaining module for receiving preconfigured patent search string stored in the database; an searching module for searching the downloaded patents to obtain search results according to the search string if the one or more reports contain the whole patent search string; a saving module for saving the search results into the database as an extensible markup language document; a creating module for creating a list according to the extensible markup language document; and a sending module for sending the list to related users if the number of the search results in the list is not null.

Another preferred embodiment provides a method for monitoring and providing patent information automatically. The method includes steps of determining whether a monitored patent Web site has issued new patents; downloading the new patents and saving the new patents into a database if the patent Web site has issued new patents; issuing one or more reports describing information of the downloaded patents; obtaining preconfigured patent search string stored in the database; determining whether the one or more reports contain the whole patent search string; searching the downloaded patents to obtain search results according to the patent search string if the one or more reports contain the whole patent search string; saving the search results into the database as an extensible markup language document; creating a list according to the extensible markup language document; determining whether the number of the search results in the list is null; and sending the list to related users if the number of the search results in the list is not null.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram of hardware configuration of a system for monitoring and providing patent information automatically in accordance with a preferred embodiment;

FIG. 2 is a schematic diagram of main function unit of an application server of FIG. 1; and

FIG. 3 is a flowchart of a preferred method for monitoring and providing patent information automatically in accordance with a preferred embodiment.

### DETAILED DESCRIPTION OF THE INVENTION

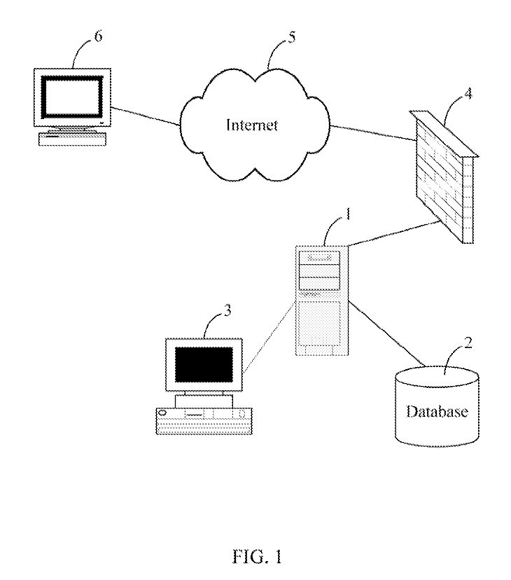

FIG. 1 is a schematic diagram of hardware configuration of a system for monitoring and providing patent information automatically (hereinafter, “the system”) in accordance with a preferred embodiment of the present invention. The system typically includes an application server 1, a database 2, and a client computer 3. The application server 1 is coupled to one or more patent Web sites 6 via the Internet 5, and is used for downloading newly issued patents and/or published patent applications from the patent Web sites 6. The database 2 connects with the application server 1, and is used for storing the downloaded patents. The client computer 3 connects with the application server 1, and is used for providing an operation interface to users. A firewall 4 is generally set between the application server 1 and the patent Web sites 6 for managing the Internet security.

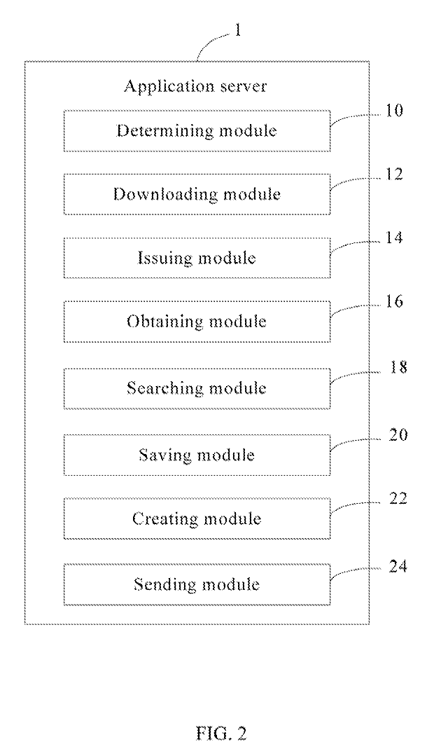

FIG. 2 is a schematic diagram of main function units of the application server 1. The application server 1 typically includes a determining module 10, a downloading module 12, an issuing module 14, an obtaining module 16, a searching module 18, a saving module 20, a creating module 22, and a sending module 24.

The determining module 10 is configured for determining whether the monitored patent Web site 6 has issued new patents. The new patents include newly issued patents and published patent applications. The patent Web site 6 may be the United States Patent and Trademark Office (USPTO) Web site, the European Patent Office (EPO) Web site, the State Intellectual Property Office of P.R China (SIPO) Web site, the Taiwan Intellectual Property Office (TIPO) Web site, etc.

The downloading module 12 is configured for downloading the new patents and saving the new patents into the database 2 if the monitored patent Web site 6 has issued new patents.

The issuing module 14 is configured for issuing one or more reports describing information of downloaded patents and saving the one or more reports into the database 2. Each report includes a patent office that issues the downloaded patents, and a type of the downloaded patents. The type of the downloaded patents may be issued patents or published patent applications.

The obtaining module 16 is configured for obtaining preconfigured patent search string from the database 2. The search string are typically set in advance and stored in the database 2, and may include keywords set for searching the new patents, the patent office that issues the new patents, and a type of the new patents. When the patent Web site 6 issues new patents, the obtaining module 16 obtains the preconfigured search string stored in the database 2 to detect the new patents.

The determining module 12 is also configured for determining whether the one or more reports contain the whole patent search string. For example, if the patent office and type of the new patents in the patent search string are the same as those in the reports, the determining module 12 determines the reports contain the whole patent search string; otherwise, the determining module 12 determines the reports do not contain the whole patent search string.

The search module 18 is configured for searching the downloaded patents to obtain search results according to the search string if the one or more reports contain the whole patent search string.

The saving module 20 is configured for saving the search results into the database 2 as an extensible markup language (XML) document.

The creating module 22 is configured for creating a list according to the XML document. The list may include the number of the search results, the keywords set in the patent search string, the patent office, a type of the corresponding search results and contact address of related users.

The determining module 10 is further configured for determining whether the number of the search results in the list is null.

The sending module 24 is configured for sending the list to related users if the number of the search results in the list is not null.

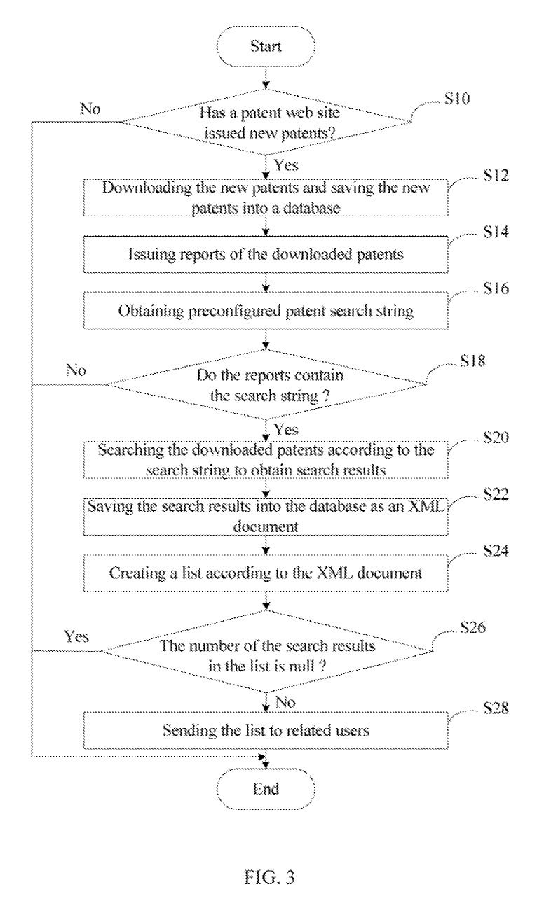

FIG. 3 is a flowchart of a preferred method for monitoring and providing patent information automatically in accordance with a preferred embodiment. In step S10, the determining module 10 determines whether the monitored patent Web site 6 has issued new patents.

If the monitored patent Web site 6 has issued new patents, in step 12, the downloading module 12 downloads the new patents and saving the new patents into a database 2.

Otherwise, if the monitored patent Web site 6 has not issued new patents, the procedure ends.

In step S14, the issuing module 14 issues one or more reports describing information of the downloaded patents and saves the one or more reports into the database 2.

In step S16, the obtaining module 16 obtains preconfigured patent search string from the database 2.

In step S18, the determining module 10 determines whether the one or more repots contain the whole patent search string.

If the one or more reports contain the whole patent search string, in step S20, the searching module 18 searches the downloaded patents to obtain search results according to the patent search string.

Otherwise, if the one or more reports do not contain the whole patent search string, the procedure ends.

In step S22, the saving module 20 saves the search results into the database 2 as an XML document.

In step S24, the creating module 22 creates a list according to the XML document.

In step S28, the determining module 10 determines whether the number of the search results in the list is null.

If the number of the search results in the list is not null, in step S28, the sending module 24 sends the list to related users.

Otherwise, if the number of the search results in the list is null, the procedure ends.

Although the present invention has been specifically described on the basis of a preferred embodiment and a preferred method, the invention is not to be construed as being limited thereto. Various converts or modifications may be made to said embodiment and method without departing from the scope and spirit of the invention.

What is claimed is:

1. A system for monitoring and providing patent information automatically comprising an application server and a database coupled to the application server, the application server being connected with one or more patent Web sites via a network, the application server comprising:
a determining module for determining whether a monitored patent Web site has issued new patents;
a downloading module for downloading the new patents and saving the new patents into the database if the monitored patent Web site has issued new patents;
an issuing module for issuing one or more reports describing information of the downloaded patents;
an obtaining module for receiving preconfigured patent search string stored in the database;
a searching module for searching the downloaded patents to obtain search results according to the search string if the one or more reports contain the whole patent search string;
a saving module for saving the search results into the database as an extensible markup language document;
a creating module for creating a list according to the extensible markup language document; and
a sending module for sending the list to related users if the number of the search results in the list is not null.

2. The system as claimed in claim 1, wherein the new patents comprise newly issued patents and published patent applications.

3. The system as claimed in claim 2, wherein the patent search string comprise keywords set for searching the new patents, a patent office that issues the new patents and a type of the new patents.

4. The system as claimed in claim 3, wherein the list comprise the number of the search results, the keywords set in the patent search string, the patent office and a type of the search results.

5. A computer-based method for monitoring and providing patent information automatically, the method comprising:
determining whether a monitored patent Web site has issued new patents;
downloading the new patents and saving the new patents into a database if the patent Web site has issued new patents;
issuing one or more reports describing information of the downloaded patents;
obtaining preconfigured patent search string stored in the database;
determining whether the one or more reports contain the whole patent search string;
searching the downloaded patents to obtain search results according to the patent search string if the one or more reports contain the whole patent search string;
saving the search results into the database as an extensible markup language document;
creating a list according to the extensible markup language document;
determining whether the number of the search results in the list is null; and
sending the list to related users if the number of the search results in the list is not null.
